(19) United States
(12) Patent Application Publication
(10) Pub. No.: US 2004/0029433 A1
(43) Pub. Date: Feb. 12, 2004

(54) Flexible coaxial adapter

(75) Inventors: Joon Lee, Des Plaines, IL (US); Nahid Islam, Westmont, IL (US)

Correspondence Address: BABCOCK IP LLC, 24154 LAKESIDE DRIVE, LAKE ZURICH, IL, 60047, US

(73) Assignee: Andrew Corporation, Orland Park, IL (US)

(21) Appl. No.: 10/064,697

(22) Filed: Aug. 7, 2002

(51) Int. Cl. H01R 13/56

(52) U.S. Cl. 439/445

(57) ABSTRACT

A flexible adapter with an outer conductor, and an inner conductor. The inner conductor generally concentric with the outer conductor; and the outer conductor and the inner conductor having a plurality of corrugations. The corrugations, for example in a bellows configuration, permitting the adapter to be bent into a range of angles. A dielectric may be located between the inner and outer conductors. The dielectric may be configured to be laterally flexible and one of axially rigid and axially extensible.

### BACKGROUND OF INVENTION

1. Field of the Invention

The invention relates to electrical cable connections. More specifically, the invention relates to a low loss flexible adapter, configurable to a range of angles.

2. Description of Related Art

Coaxial cables commonly have a specified radius of curvature that identifies the maximum bend radius recommended for the cable, before cable signal transmission characteristics degrade and or physical cable damage occurs. Where cable routing or interconnection needs present a requirement for a bend larger than the specified radius of curvature, angled coaxial adapters/connectors may be used.

Adapters with a fixed bend angle, for example 45 or 90 degrees have previously been available. Fixed bend angle adapters require anticipation of the required bend angle. Further, to handle a range of possible bend angles, a fixed bend angle adapter manufacturer must manufacture and stock a variety of discrete components covering an anticipated range of bend angles resulting in manufacturing inefficiencies and significant inventory carry charges. Likewise, an adapter user must anticipate his or her adapter needs and or order redundant components.

Adapters with a variable bend angle have previously been available. For example, to permit an increased radius of curvature, a short section of reduced diameter coaxial cable may be used between a pair of coaxial connectors. Use of a flexible adapter with this configuration requires the user to accept a degradation of signal transmission/line loss characteristics due to the section of smaller diameter center conductor and a reduced radius to the shield conductor. Other “Flexible Adapters” that minimize cable signal/line loss characteristics have generally been unable to provide more than a limited bend angle over the specified radius of curvature of the coaxial cable they are dimensioned to couple with.

Therefore, it is an object of the invention to provide a flexible adapter that overcomes deficiencies in the prior art.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 shows an external isometric view of a flexible adapter according to one embodiment of the invention.

FIG. 2 shows an isometric sectional view of the flexible adapter of FIG. 1.

FIG. 3 shows a side sectional view of the flexible adapter of FIG. 1.

FIG. 4 shows an isometric view of the flexible adapter of FIG. 1, arranged with a 90 degree bend angle.

FIG. 5 shows an isometric sectional view of the dielectric of the flexible adapter of FIG. 1.

FIG. 6 shows an extended length flexible adapter, usable to connect devices with an axial offset.

FIG. 7 shows side sectional view of a coaxial cable with an integral flexible adapter on one end.

FIG. 8 shows a schematic view of a flexible portion, used to make a connection internal to a device.

FIG. 9 shows a side sectional view of an extensible flexible portion.

### DETAILED DESCRIPTION

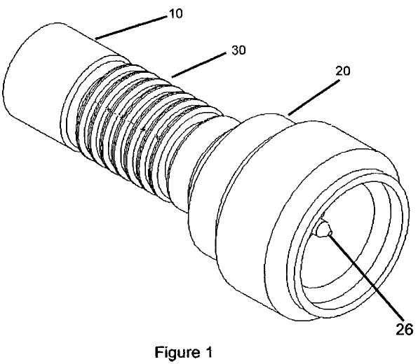

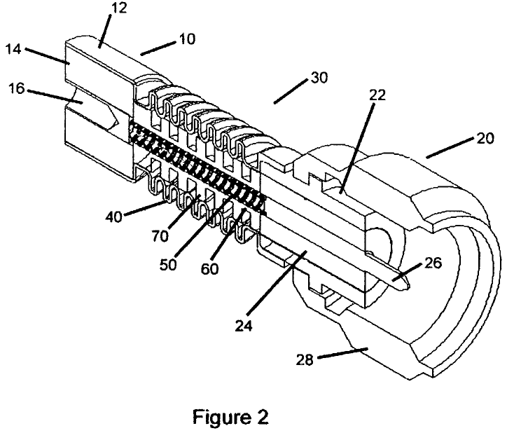

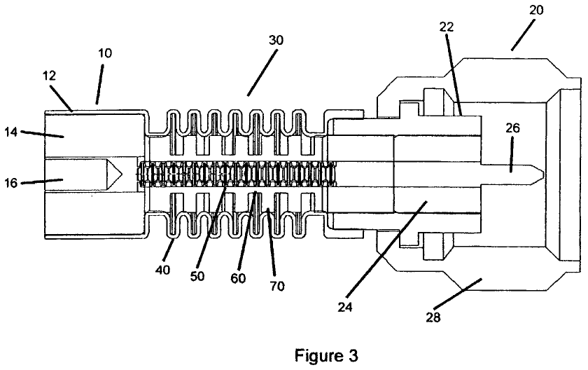

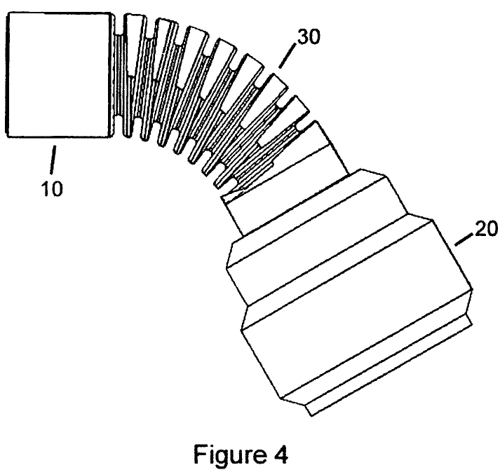

One embodiment of a flexible adapter, for example an in-line SMA type flexible adapter, is shown in FIGS. 1-4. Use of a corrugated or bellows type inner conductor, a dielectric insulator/spacer and a corrugated or bellows type outer conductor permits the flexible connector to be bent into a range of angles without significant degradation of the flexible connector's signal transmission/line loss characteristics.

The specific form of interconnection between the flexible adapter and other devices/cables may depend on the flexible adapter's coaxial cable diameter and or the application the flexible adapter is intended for. A first end 10 and a second end 20 of the flexible adapter may be configured with connectors selected to mate with any type of connector mounted on a device/cable using, for example, standard N, BNC, SMA, DIN, UHF, CATV, and or EIA connectors, or a proprietary connector configuration. The connectors of the flexible adapter may be configured, for example, with male and female type connectors for in-line insertion, or as male/male or female/female connectors, thereby adding a gender changing function to the flexible adapter. Alternatively, reverse polarity (gender) connectors may be used. Further, different types of connectors may be used at the first end 10 and second end 20 to create a connector interface functionality.

Depending on the connector type used, the first end connector 10 and the second end connector 20 may have different elements. In the case of a male/female in-line SMA type connector, first end connector 10 may have a first annular surface 12, a first dielectric 14 and a center aperture 16. Second end connector 20 may have a second annular surface 22, a second dielectric 24, a center protrusion 26 and a collar 28.

The first end connector 10 and the second end connector 20 are coupled to first and second ends of a flexible portion 30. The flexible portion 30 may comprise a corrugated outer conductor 40 and or inner conductor 50.

Corrugation, as used in this specification, is defined as any form of structure having a pattern of peaks and valleys, for example as in a bellows, annular rib, helical groove, ribbed or zig-zag construction. Corrugation and or bellows density of the outer conductor 40 and or inner conductor 50, i.e. the number of corrugations and or bellows sections per unit length, and the depth of each corrugation and or bellows are factors contributing to flexibility of the resulting flexible connector with higher densities, and or larger depths generally resulting in higher flexibility.

The outer conductor 40 and or inner conductor 50 may be formed from a conductive material, for example copper, nickel, silver or a coated or electro coated metal or metal alloy. Outer conductors 40 and inner conductors 50 with high density and or depth characteristics may be formed using electrodeposition techniques. A protective coating on the outside of the outer conductor 40, for example polyethylene, may be used to minimize environmental exposure.

The outer conductor 40 may be electrically coupled with outer conductor sections of the first end connector 10 and the second end connector 20. The inner conductor 50 may be coupled with inner conductor sections of the first end connector 10 and the second end connector 20. In the case of the SMA type flexible adapter embodiment shown in FIGS. 1-4, the first connector annular outer surface 12 and second connector annular surface 22 are electrically coupled to outer conductor 40. Also, the center aperture 16 and center protrusion 26 are electrically coupled to inner conductor 50.

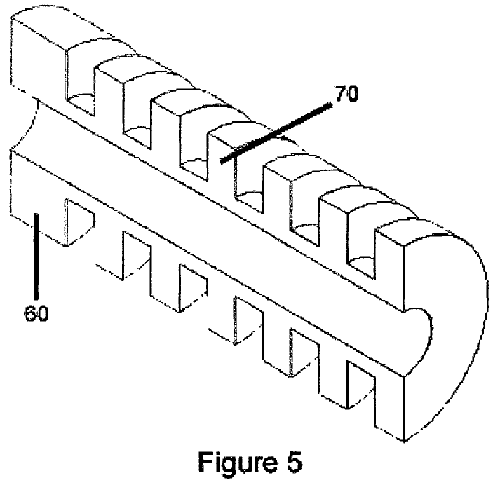

A dielectric 60 may be used to maintain the inner conductor 50 generally concentric within the outer conductor 40. The dielectric 60 may be formed from any suitable dielectric material with acceptable dielectric and lateral flexibility characteristics, for example PTFE, polyethylene or polyethylene foam. Forming annular ribs 70 in an outer surface of the dielectric 60, for example as shown in FIG. 5, or other patterns of outer surface material removal may increase the lateral flexibility characteristics of the resulting flexible connector while maintaining axial rigidity, thereby limiting axial extension of the flexible connector.

A length of the flexible portion 30 may be increased or decreased for a given combination of outer conductor 40, inner conductor 50 and, if present, dielectric 60 to change a flexibility range of the resulting flexible connector. For example, flexible connectors having a bend range of 0 to 90 degrees or 0 to 180 degrees may be formed from the same conductor/dielectric materials by changing the length of the flexible portion 30.

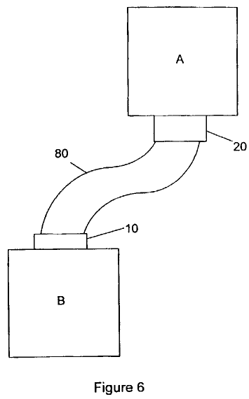

A flexible adapter with an extended flexible portion 80 may be used to couple cables/devices A and B that, for example by design or installation error, have an axial offset, as shown in FIG. 6.

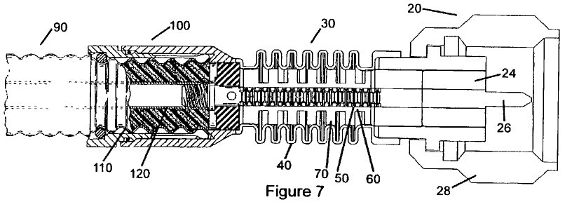

In a second embodiment, as shown in FIG. 7, the flexible adapter may be integrated with a cable 90, located on one or both ends of the cable 90. Because the coupling between the flexible adapter and the end of the cable may be permanent, the coupling components may be less complex. Also, for example, the coupling may be factory rather than field installed which may increase manufacturing efficiency as well as resulting coupling quality and or durability characteristics.

When a flexible adapter according to the invention is coupled with, for example, a heliacally corrugated coaxial cable 90 the coupling may be formed using a cable end connector 100 which threads into and or onto the heliacal corrugations of the cable outer conductor 110 and or cable inner conductor 120, as described in U.S. Pat. No. 5,595,502 “Connector for coaxial cable having hollow inner conductor and Method of attachment” assigned to Andrew Corporation, issued Jan. 21, 1997 and hereby incorporated by reference in the entirety.

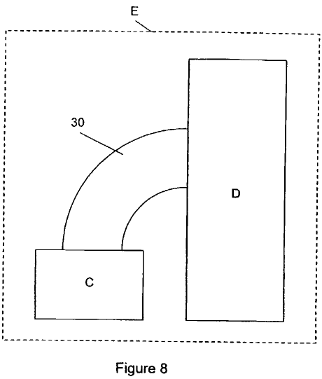

In a third embodiment, as shown in FIG. 8, the flexible portion 30 or extended flexible portion 80 may be used without first end connector 10 and or second end connector 20, installed directly between, for example, components C and D within a device E.

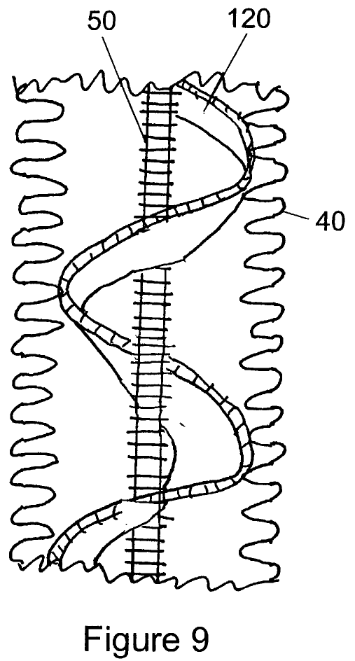

In any of the prior embodiments, if the dielectric 60 is omitted or configured to be axially extensible, for example configured as a spiral spacer 120 in an otherwise air dielectric coaxial cable, as shown in FIG. 9, or with an elastic foam dielectric a flexible adapter with a variable length may be formed. Variable length flexible adapters are useful in applications where the exact distance between devices/cables may not be known or fixed in advance.

As described, the flexible connector provides the following advantages. The flexible connector has a continuous range of bend angles, allowing a single flexible connector to replace several different fixed angle connectors. The flexible connector does not sacrifice signal transmission and or line loss characteristics. The flexible connector may have a fixed or variable axial length despite having a wide range of lateral flexibility. The flexible connector may have a diameter common to coaxial cables it is coupled with, allowing feeding of the connector through tight spaces, bulkheads and or conduit.

Table of Parts

| | |
|---|---|
| 10 | first end connector |
| 12 | first annular surface |
| 14 | first dielectric |
| 16 | center aperture |
| 20 | second end connector |
| 22 | second annular surface |
| 24 | second dielectric |
| 26 | center protrusion |
| 28 | collar |
| 30 | flexible portion |
| 40 | outer conductor |
| 50 | inner conductor |
| 60 | dielectric |
| 70 | rib |
| 80 | extended flexible portion |
| 90 | cable |
| 100 | cable outer conductor |
| 110 | cable inner conductor |
| 120 | spiral spacer |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A flexible adapter, comprising:
an outer conductor;
an inner conductor;
a means for connection; and
the inner conductor generally concentric with the outer conductor; and
the outer conductor and the inner conductor having a plurality of corrugations.

2. The adapter of claim 1, further including a dielectric located between the outer conductor and the inner conductor.

3. The adapter of claim 2, further including a plurality of ribs formed in an outer surface of the dielectric.

4. The adapter of claim 2, wherein the dielectric is one of polyethylene, PTFE and polyethylene foam.

5. The adapter of claim 2, wherein the dielectric is axially rigid and laterally flexible.

6. The adapter of claim 1, wherein the means for connection is
a first connector coupled with a first end of the outer conductor and the inner conductor; and
a second connector coupled with a second end of the outer conductor and the inner conductor.

7. The adapter of claim 6, wherein at least one of the first connector and the second connector is one of a N, BNC, SMA, DIN, UHF, CATV, EIA and reverse polarity connector.

8. The adapter of claim 6, wherein the first connector is a male connector and the second connector is a female connector.

9. The adapter of claim 6, wherein the first connector and the second connector are one of male and female connectors.

10. The adapter of claim 6, wherein the first connector has a first connector type and the second connector has a second connector type.

11. The adapter of claim 1, wherein at least one of the outer conductor and the inner conductor are formed using electrodeposition.

12. The adapter of claim 1, wherein at least one of the outer conductor and the inner conductor are one of a metal alloy, copper, nickel, silver and gold.

13. A flexible adapter, comprising:
a first coaxial connector;
a second coaxial connector; and
a coaxial flexible section having
a first end,
a second end,
an outer conductor, and
an inner conductor;
the first coaxial connector coaxially coupled with the first end and the second coaxial connector coaxially coupled with the second end; and
the outer conductor and the inner conductor having a plurality of corrugations.

14. The adapter of claim 13, further including a dielectric located between the outer conductor and the inner conductor.

15. The adapter of claim 14, wherein the dielectric is ribbed.

16. The adapter of claim 14, wherein the dielectric is one of polyethylene, PTFE, and polyethylene.

17. The adapter of claim 13, wherein at least one of the first connector and the second connector is one of a N, BNC, SMA, DIN, UHF, CATV, EIA and reverse polarity connector.

18. The adapter of claim 13, wherein the first connector is a male connector and the second connector is a female connector.

19. The adapter of claim 13, wherein the first connector and the second connector are one of male and female connectors.

20. The adapter of claim 13, wherein the first connector has a first connector type and the second connector has a second connector type.

21. The adapter of claim 13, wherein at least one of the outer conductor and the inner conductor are formed using electrodeposition.

22. The adapter of claim 13, wherein at least one of the outer conductor and the inner conductor are one of a metal alloy, copper, nickel, silver and gold.

23. A method for making a flexible adapter, comprising the steps of:
forming at least one of a corrugated inner conductor and a corrugated outer conductor by electrodeposition;
arranging the inner conductor within the outer conductor; and
connecting a first end of the inner conductor and the outer conductor to a first connector and a second end of the inner conductor and the outer conductor to a second connector.

24. The method of claim 23, further including the step of placing a dielectric between the inner conductor and the outer conductor.

25. The method of claim 24, further including the step of forming a plurality of ribs in an outer surface of the dielectric.

26. The method of claim 23, wherein at least one of the inner conductor and the outer conductor is one of a metal alloy, copper, nickel, silver and gold.

27. The method of claim 23, wherein at least one of the first connector and the second connector is one of a N, BNC, SMA, DIN, UHF, CATV, EIA and reverse polarity connector.

28. The method of claim 24, wherein the dielectric is one of PTFE, polyethylene and polyethylene foam.

29. A flexible dielectric for coaxial conductors, comprising:
a dielectric material dimensioned for location between an inner conductor and an outer conductor;
the dielectric material having a plurality of ribs in an outer surface.

30. The dielectric of claim 29, wherein the dielectric material is one of PTFE, polyethylene and polyethylene foam.

31. The dielectric of claim 29, wherein the dielectric material is axially rigid and laterally flexible.

32. A coaxial cable with a flexible end portion, comprising:
a coaxial cable having at least one flexible end portion;
the flexible end portion having a corrugated inner conductor and a corrugated outer conductor;
a first end of the corrugated inner conductor coupled with an inner conductor of the coaxial cable; and
a first end of the corrugated outer conductor coupled with an outer conductor of the coaxial cable.

33. The cable of claim 32, further including a coaxial connector coupled to a second end of the corrugated inner conductor and a second end of the corrugated outer conductor.

34. The cable of claim 32, further including a dielectric between the corrugated inner conductor and the corrugated outer conductor.

35. The cable of claim 33, further including a plurality of ribs in an outer surface of the dielectric.

36. The cable of claim 32, wherein at least one of the corrugated inner conductor and the corrugated outer conductor is formed by electrodeposition.

37. A flexible and extensible adapter, comprising:
an outer conductor;
an inner conductor; and
a means for connection;
the inner conductor generally concentric with the outer conductor;
the outer conductor and the inner conductor having a plurality of corrugations; and
the outer conductor and the inner conductor extensible in an axial direction.

38. The adapter of claim 37, further including a dielectric located between the outer conductor and the inner conductor.

39. The adapter of claim 38, further including a plurality of ribs formed in an outer surface of the dielectric.

40. The adapter of claim 38, wherein the dielectric is one of polyethylene, PTFE and polyethylene foam.

41. The adapter of claim 38, wherein the dielectric has a spiral configuration.

42. The connector of claim 37, wherein the means for connection is
a first connector coupled with a first end of the outer conductor and the inner conductor; and
a second connector coupled with a second end of the outer conductor and the inner conductor.

43. The connector of claim 42, wherein at least one of the first connector and the second connector is one of a N, BNC, SMA, DIN, UHF, CATV, EIA and reverse polarity connector.

44. The connector of claim 42, wherein the first connector is a male connector and the second connector is a female connector.

45. The connector of claim 42, wherein the first connector and the second connector are one of male and female connectors.

46. The connector of claim 42, wherein the first connector has a first connector type and the second connector has a second connector type.

47. The connector of claim 37, wherein at least one of the outer conductor and the inner conductor are formed using electrodeposition.

48. The connector of claim 37, wherein at least one of the outer conductor and the inner conductor are one of a metal alloy, copper, nickel, silver and gold.

49. A flexible coaxial portion for interconnecting devices, comprising:
an outer conductor; and
an inner conductor;
the inner conductor generally concentric with the outer conductor; and
the outer conductor and the inner conductor having a plurality of corrugations; and
at least one of the inner conductor and the outer conductor is formed by electro deposition.

50. The adapter of claim 49, further including a dielectric located between the outer conductor and the inner conductor.

51. The adapter of claim 50, further including a plurality of ribs formed in an outer surface of the dielectric.

52. The adapter of claim 50, wherein the dielectric is one of polyethylene, PTFE and polyethylene foam.

53. The adapter of claim 50, wherein the dielectric is axially rigid and laterally flexible.

54. The adapter of claim 50, wherein the dielectric is axially extensible and laterally flexible.
